(19) United States
(12) Patent Application Publication
(10) Pub. No.: US 2025/0329240 A1
(43) Pub. Date: Oct. 23, 2025

(54) ELECTRONIC DEVICE NETWORK WITHIN AN ENVIRONMENT

(71) Applicant: MASIMO CORPORATION, Irvine, CA (US)

(72) Inventors: Massi Joe E. Kiani, Laguna Niguel, CA (US); Kristian King, Kingswear (GB); Brendon Stead, Carlsbad, CA (US)

(21) Appl. No.: 19/180,882

(22) Filed: Apr. 16, 2025

Related U.S. Application Data
(60) Provisional application No. 63/635,553, filed on Apr. 17, 2024.

(51) Int. Cl. G08B 21/04; G06V 20/52; G08B 3/10

(52) U.S. Cl. CPC G08B 21/0438; G06V 20/52; G08B 3/10

(57) ABSTRACT

A device environment can include a plurality of devices, including an audio device, in communication over a network. An audio device (such as a soundbar) can comprise a speaker, a camera, and other sensors. The audio device can receive information from other devices in the environment including image data from other cameras and physiological data from wearable devices, etc. The audio device can monitor and control aspects of the environment. The audio device can provide information to the user including audible notifications, and can monitor the user including the user's position or physiological condition, alone or in combination with other devices in the environment.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to home automation and physiological monitoring.

### BACKGROUND

Various devices within an environment can connect and share information. The devices can automatically perform operations to enhance a user's experience within the environment. For example, an audio device can have audio speakers that can emit audio within an environment.

### SUMMARY

Disclosed herein is a soundbar for monitoring a user's environment with enhanced privacy that can comprise: a speaker configured to emit audio; a position sensor configured to monitor an environment with microwave radiation and generate position data of the environment responsive to detecting the microwave radiation; a camera configured to generate image data of an environment, the camera configured to transition between a monitor mode and a standby mode; and one or more hardware processors that can be configured to: access position data originating from the position sensor indicating a position of a user within the environment; in response to determining from the position data that an adverse event has occurred in the environment corresponding to physiological distress of the user, transition the camera from the standby mode to the monitor mode to monitor the environment based on determining that a safety of the user during the adverse event outweighs a privacy of the user; communicate the image data to a remote computing device; and generate an audible alert from the speaker.

In some implementations, the adverse event is a user fall.

In some implementations, the adverse event is a change in the user's breathing.

In some implementations, the one or more hardware processors are configured to generate a notification that additional monitoring will commence in response to determining from the position data that the adverse event has occurred.

In some implementations, the one or more hardware processors are configured to transition the camera to the monitor mode by at least powering on the camera.

In some implementations, the audio device comprises a buffer configured to store image data from the camera as non-persistent data, and the one or more hardware processors are configured to transition the camera to the monitor mode by at least changing a length of time the image data persists in the buffer before being deleted.

In some implementations, the audio device comprises a buffer configured to store image data from the camera as non-persistent data, wherein the one or more hardware processors are configured to transition the camera to the monitor mode by at least storing the image data from the buffer in long term memory as persistent data.

In some implementations, the image data includes data generated by the camera before and/or during the adverse event when the camera is in the standby mode, wherein the image data is stored in a buffer as non-persistent data during the standby mode.

In some implementations, the one or more hardware processors are configured to verify that the adverse event has occurred from the image data generated by the camera.

In some implementations, the one or more hardware processors are configured to determine the adverse event has occurred if a condition in the position data persists for longer than a threshold.

In some implementations, the audio device includes an environment sensor, wherein the one or more hardware processors are configured to: access user agnostic data originating from the environment sensor, said user agnostic data including one or more of environment temperature data, ambient light data, or air quality data; and determine that the adverse event has occurred from the user agnostic data in combination with the position data.

In some implementations, the audio device includes a microphone, wherein the one or more hardware processors are configured to: access audio data originating from the microphone; and determine that the adverse event has occurred from the audio data in combination with the position data.

In some implementations, the one or more hardware processors are configured to: access physiological data originating from a user device connected to the user; and determine that the adverse event has occurred from the physiological data in combination with the position data.

Disclosed herein is a method of monitoring an environment with an audio device. The method can comprise accessing position data originating from a position sensor responsive to detecting microwave radiation within the environment, said position data indicating a position of a user within the environment; in response to determining from the position data that an event has occurred in the environment, transitioning a camera from a standby mode to a monitor mode to monitor the environment within images collected by the camera; communicating the images to a remote computing device; and generating an audible alert from a speaker of the audio device relating to the event.

In some implementations, the method can comprise generating a notification that additional monitoring will commence in response to determining from the position data that the event has occurred.

In some implementations, the method can comprise storing the images from the camera in a buffer as non-persistent data, wherein transitioning the camera to the monitor mode includes at least changing a length of time the images persist in the buffer before being deleted.

In some implementations, the method can comprise: accessing user agnostic data originating from an environment sensor, said user agnostic data including one or more of environment temperature data, ambient light data, or air quality data; and determining that the event has occurred from the user agnostic data in combination with the position data.

Disclosed herein is non-transitory computer-readable media including computer-executable instructions that, when executed by a computing system, cause the computing system to perform operations that can comprise: accessing position data originating from a position sensor responsive to detecting microwave radiation within an environment, said position data indicating a position of a user within the environment; in response to determining from the position data that an event has occurred in the environment, transitioning a camera from a standby mode to a monitor mode to monitor the environment within images collected by the camera; communicating the images to a remote computing device; and generating an audible alert relating to the event from a speaker of an audio device.

In some implementations, the computer-executable instructions, when executed by the computing system, cause the computing system to perform operations comprising generating a notification that additional monitoring will commence in response to determining from the position data that the event has occurred.

In some implementations, the computer-executable instructions, when executed by the computing system, cause the computing system to perform operations comprising storing the images from the camera in a buffer as non-persistent data, wherein transitioning the camera to the monitor mode includes at least changing a length of time the images persist in the buffer before being deleted.

Disclosed herein is an audio device which can comprise: a speaker configured to emit audio; a camera configured to generate image data of an environment, the camera configured to transition between a monitor mode and a standby mode; and one or more hardware processors which can be configured to: access motion data originating from a user device, the motion data based on motion of the user device; in response to determining from the motion data that a user has fallen: monitor the environment with the camera in the monitor mode responsive to determining that the user device is within a threshold distance to the audio device; and verify that the user has fallen from image data generated by the camera; and in response to verifying that the user has fallen: generate an audible alert from the speaker; and communicate the image data to a remote computing device.

In some implementations, the motion data originates from a motion sensor of the user device and indicates linear acceleration and/or angular velocity of the user device.

In some implementations, the motion data indicates whether a user fall has been detected.

In some implementations, the audio device comprises a soundbar.

Disclosed herein is an audio device which can comprise: a speaker configured to emit audio; a camera configured to generate image data of a user; and one or more hardware processors which can be configured to: communicate the image data to a remote computing device configured to analyze the image data with machine learning using a dataset of pre-characterized images; receive an analysis of the image data from the remote computing device indicating a health condition of the user; communicate the image data and the analysis to a healthcare provider device responsive to determining that the analysis satisfies a condition; and generate an audible notification from the speaker indicative of the analysis.

In some implementations, the audio device comprises a soundbar.

Disclosed herein is an audio device which can comprise: a speaker configured to emit audio; a pulse oximeter disposed on a housing of the audio device, the pulse oximeter configured to implement trans-reflectance photoplethysmography with an optical emitter and an optical detector; and one or more hardware processors which can be configured to: access physiological data of a user originating from the pulse oximeter; determine variations in volume of pulsatile blood flow of the user based on the physiological data, the variations in volume of pulsatile blood flow indicating at least a pulse rate of the user; determine an audio playback based on the pulse rate; and cause the speaker to emit the audio playback.

In some implementations, the one or more hardware processors are further configured to: access auxiliary physiological data from a remote user device comprising one or more physiological sensors; and determine the audio playback based on the pulse rate and the auxiliary physiological data.

In some implementations, the audio device comprises a soundbar.

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise a computer-readable storage medium having program instructions embodied therewith, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising a computer-readable storage medium are disclosed, wherein the computer-readable storage medium has program instructions embodied therewith, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

Various implementations will be described hereinafter with reference to the accompanying drawings. These implementations are illustrated and described by example only, and are not intended to limit the scope of the disclosure. In the drawings, similar elements may have similar reference numerals.

FIG. 1 is a block diagram illustrating an environment of various devices in communication with each other over a network.

FIG. 2 is a block diagram illustrating an example implementation of a soundbar.

FIG. 3 shows an example soundbar.

FIGS. 4A-4C illustrate example implementations of a soundbar.

FIG. 5 illustrates an example implementation of a soundbar.

FIGS. 6-7 are flowcharts illustrating example processes for monitoring an environment and/or user with a position sensor.

FIGS. 8A-8B illustrate an example display device displaying example user interfaces.

### DETAILED DESCRIPTION

The present disclosure will now be described with reference to the accompanying figures, wherein like numerals may refer to like elements throughout. The following description is merely illustrative in nature and is in no way intended to limit the disclosure, its application, or uses. Furthermore, the devices, systems, and/or methods disclosed herein can include several novel features, no single one of which is solely responsible for its desirable attributes or which is essential to practicing the devices, systems, and/or methods disclosed herein. Additionally, the structures, systems, and/or devices described herein may be embodied as integrated components or as separate components.

Some aspects and/or implementations have been described in connection with the accompanying drawings. The figures may be drawn to scale, but such scale is not limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps. Various steps within a method may be executed in different order without altering the principles of the present disclosure.

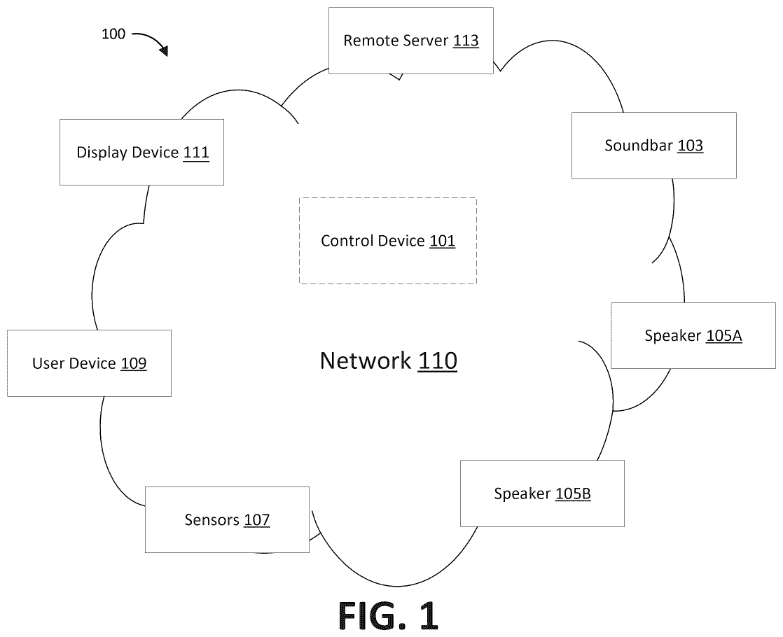

FIG. 1 is a block diagram illustrating a device environment 100 of various devices in communication with each other over network 110. The devices can include a control device 101, a soundbar 103, speakers 105 (e.g., speakers 105A, 105B), sensors 107, user devices 109, a display device 111, and a remote server 113. The device environment 100 can include additional or alternative audiovisual (AV) devices, such as amplifiers, audio and/or video streaming devices, etc. The device environment 100 can be implemented, at least partially, in an environment such as a home, a school, a workplace, or a healthcare facility. One or more of the devices in device environment 100 can be in the same environment, such as a home, and one or more other devices in the device environment 100 can be in a remote location. For example, the remote server 113 can be remote to other devices in the device environment 100. The term ‘device environment 100’ may be used herein to refer to all of the devices shown in FIG. 1 collectively, or to any of the devices individually, or to any combination of less than all of the devices. For example, reference to the device environment 100 may refer specifically (and only) to the control device 101 or specifically (and only) to the soundbar 103. As another example, reference to the device environment 100 may refer to the soundbar 103, the sensors 107, and the user device 109 (or any other possible combination of devices shown and/or described).

The network 110 can include one or more communications networks. The network 110 can include a plurality of computing devices configured to communicate with one another. The network 110 can include routers. The network 110 can include the Internet. The network 110 can include a cellular network. The network 110 can include any combination of a body area network (e.g., implementing human body communication with capacitive coupling via the tissue of a user's body), a local area network (“LAN”) and/or a wide area network (“WAN”), or the like. Accordingly, various computing devices of the device environment 100, can communicate with one another directly or indirectly via any appropriate communications links and/or networks, such as network 110 (e.g., one or more communications links, one or more computer networks, one or more wired or wireless connections, the Internet, any combination of the foregoing, and/or the like).

Communication over the network 110 can include a variety of communication protocols, including wired communication, wireless communication, wire-like communication, near-field communication (such as inductive coupling between coils of wire or capacitive coupling between conductive electrodes), and far-field communication (such as transferring energy via electromagnetic radiation (e.g., radio waves)). Example communication protocols can include Wi-Fi, Bluetooth®, ZigBee®, Z-wave®, cellular telephony, such as long-term evolution (LTE) and/or 1G, 2G, 3G, 4G, 5G, etc., infrared, radio frequency identification (RFID), satellite transmission, inductive coupling, capacitive coupling, proprietary protocols, combinations of the same, and the like.

The control device 101 can control operation of any of the other devices in the device environment 100. The control device 101 can comprise one or more hardware processors configured to execute program instructions to cause the control device 101 to perform operations. The control device 101, or hardware processors thereof, can generate instructions to control operation of other devices in the device environment 100. The control device 101 can communicate instructions to other devices in the device environment 100 to control their operation. In some implementations, the control device 101 may be representative of any of the other devices shown and/or described in the device environment 100. For example, the soundbar 103 may be the control device 101, the speakers 105 may be the control device 101, etc. Accordingly, operational features described with respect to control device 101 may also apply to other devices within the device environment 100. Any of the devices in the device environment 100 can control and/or be controlled by any of the other devices. Accordingly, the device environment 100 may be a distributed computing environment wherein each of the devices performs computing processes for controlling operation of themselves or other devices. The device environment 100 may not have a central processing device such as control device 101 that performs processing functions for other devices in the device environment 100.

Control device 101 may be implemented as, and/or integrated with, a home automation system, such as a security system, a thermostat system, or a lighting system. Control device 101 can control one or more aspects of an environment such as temperature. For example, the control device 101 may access data originating from sensors 107 relating to the environment, such as temperature data, image data, or audio data of the environment, and can control aspects of the environment based on that sensor data, such as turning on a heater to adjust the environment temperature or controlling a camera to obtain image data of the environment. Control device 101 can control lighting of the environment by adjusting lights such as by turning lights on or off, or by adjusting a brightness of lights.

The soundbar 103 may also be referred to as an audio device. The soundbar 103 can emit audio and may have processing and/or computing functionality. The soundbar 103 can comprise structural and/or operational features of any of the other example soundbars shown and/or described herein. In some implementations, the soundbar 103 may be the control device 101 and may control operations of other devices in the device environment 100. The soundbar 103 can send and/or receive data from other devices in the device environment 100. The soundbar 103 can communicate data to the remote server 113 (or other devices) such as image data, audio data, temperature data, user interface data, or physiological data. The soundbar 103 can receive data from the remote server 113 (or other devices) such as image data, audio data, temperature data, user interface data, or physiological data.

Speakers 105 can emit audio. Speakers 105 can emit audio based on audio data and/or instructions originating from soundbar 103. Speakers 105 can be integrated with soundbar 103 or may be remote to the soundbar 103. Speakers 105 can be near each other in a same environment or can be remote to one another in different locations or environments. For example, speaker 105A can be in one room in an environment (e.g., a home or hospital) and speaker 105B can be in a different room in that same environment. Speaker 105A and speaker 105B can emit audio independently of one another or in conjunction with one another. Speakers 105 (and/or soundbar 103) can emit audio (or cease to emit audio or adjust audio volume) in response to one or more conditions such as when a doorbell is rung. This can alert a user someone is at the door or can decrease volume of audio to allow the user to interact with the person at the door. Speakers 105 (and/or soundbar 103) can emit an audio alert in response to suspicious activity. Speakers 105 can comprise one or more sensors, such as any of the example sensors 107, such as cameras and/or temperature sensors, such that the speakers 105 may provide a distributed network of sensors if the speakers 105 are distributed at various locations throughout an environment.

Sensors 107 can include one or more sensors which may be located in the same or different locations. For example, sensors 107 may be distributed throughout an environment (e.g., different rooms in a home) or may be located within the same room or portion of an environment. Sensors 107 can be integrated with any of the other devices in device environment 100. For example, sensors 107 can be integrated within a same housing as soundbar 103, within a same housing as speakers 105, or within a same housing as user device 109. For example, a camera may be integrated with speakers 105 and a physiological sensor may be integrated with user device 109. Sensors 107 can be implemented within a system such as a home security system or a home thermostat system.

Sensors 107 can include one or more types of sensors, such as temperature sensors, cameras, position sensors, proximity sensors, motion sensors, ultrawide band (UWB) sensors, mmWave sensors, acoustic sensors such as microphones, light sensors, or inertial sensors. Sensors 107 can collect data from the environment such as temperature data, image data, audio data including ambient noise level, ambient light level, etc. Sensors 107 can include physiological sensors configured to collect physiological data of a user. Physiological sensors can include one or more of acoustic sensors, optical sensors, inertial sensors, temperatures sensors, electrical sensors, voltage sensors, impedance sensors, an oximeter, etc. Sensors 107 can implement photoplethysmography (PPG) to measure volumetric variation in blood circulation and derive one or more parameters therefrom, such as pulse rate, blood pressure, respiration rate, cardiac output, perfusion index, pleth variability index, PPG waveform data, blood oxygen saturation, etc. Sensors 107 can include one or more optical emitters configured to emit optical radiation of a plurality of wavelengths, which may include visible light. Sensors 107 can include one or more optical detectors configured to detect optical radiation attenuated by the tissue of subject (which may have been emitted by optical emitters) and generate data relating to the pulsatile characteristics of the subject, including blood oxygen saturation, hydration, hemoglobin content, etc. Sensors 107 can include electrocardiogram (ECG) sensors, including one or more electrodes, configured to measure electrical activity of the subject, such as cardiac signals. Sensors 107 can include electroencephalography (EEG) sensors. Sensors 107 can measure and/or generate data relating to respiration rate, blood oxygen saturation (e.g., SpO2), heart rate, pulse rate, skin temperature, core body temperature, spatial orientation, or the like.

User device 109 may be a computing device. User device 109 can be a laptop, tablet, computer, smartphone, smartwatch, wearable device, auricular device, a controller device (such as a handheld remote controller), or the like. The user device 109 can comprise hardware processors configured to execute program instructions to cause the user device 109 (or other devices) to perform operations. The user device 109 can comprise sensors, such as sensors 107.

Display device 111 can comprise a screen configured to display user interfaces, such as any of the example user interfaces, or aspects thereof, that are shown and/or described herein. The display device 111 can comprise an LED screen, an LCD screen, an OLED screen, a QLED screen, a plasma display screen, a quantum dot display screen, or the like. The display device 111, or screen thereof, may be responsive to touch. For example, the display device 111 may comprise a touchscreen such as a resistive touchscreen, a capacitive touchscreen, an infrared touchscreen, a surface acoustic wave touchscreen, or the like. The display device 111 can be in a fixed location such as a screen mounted to a wall. The display device 111 can be a TV screen or a computer monitor. The display device 111 can be integrated in a handheld device. The display device 111 can be integrated with user device 109 or soundbar 103. The display device 111 can display indicia of physiological data which can originate from sensors 107 and/or user device 109. The display device 111 can display user interfaces based on data originating from any of the devices in the device environment 100, such as the soundbar 103. The display device 111 can display user interfaces based on image data originating from remote cameras. For example, the display device 111 display image data originating from a home security camera mounted on an exterior region of a home (such as near a front door or by a doorbell) such that a user can view images of the exterior of their home via the display device 111. The display device 111 can display historical images previously captured or real-time images as the images are captured. The display device 111 can display images in response to one or more conditions such as when a doorbell is rung, when motion is detected, when suspicious activity is detected, when a physiological condition is detected, or the like.

The remote server 113 can comprise one or more computing devices including one or more hardware processors. The remote server 113 can comprise program instructions configured to cause the remote server 113 to perform one or more operations when executed by the hardware processors. The remote server 113 can include, and/or have access to (e.g., be in communication with and/or host) a storage device, database, or system which can include any computer readable storage medium and/or device (or collection of data storage mediums and/or devices), including, but not limited to, one or more memory devices that store data, including without limitation, dynamic and/or static random-access memory (RAM), programmable read-only memory (PROM), erasable programmable read-only memory (EPROM), electrically erasable programmable read-only memory (EEPROM), optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. In some implementations, the remote server 113 may include and/or be in communication with a hosted storage environment that includes a collection of physical data storage devices that may be remotely accessible and may be rapidly provisioned as needed (commonly referred to as “cloud” storage). Data stored in and/or accessible by the remote server 113 can include physiological data including historical physiological data. In some implementations, the remote server 113 may comprise and/or be in communication with an electronic medical records (EMR). An EMR can comprise a propriety EMR. An EMR can comprise an EMR associated with a hospital. An EMR can store data including medical records.

The device environment 100 can monitor a user's location within an environment. For example, sensors 107 (or sensors embodied within speakers 105, soundbar 103, or other devices) can monitor a user's location. A variety of sensors can monitor the user's location such as cameras which can collect image data with visible light, UWB or mm Wave sensors which can use microwave electromagnetic radiation to ascertain position data, or other proximity, position, or motion sensors. In some implementations, monitoring a user's location with UWB and/or mm Wave sensors can enhance security/privacy because UWB and mmWave can monitor a user's location without collecting image data with visible light that can be deciphered by a human. Accordingly, the device environment 100 can monitor a user's location without collecting images of the user, such as of the user's face etc. In some implementations, the device environment 100 can monitor a user location based on at least GPS data originating from a wearable or mobile device with the user, such as user device 109.

The device environment 100 can play audio based on a user's location within an environment. For example, the speaker 105A, speaker 105B, and soundbar may be located within a different portion of an environment such as within different rooms or different portions of a room and as the user moves about within the environment (e.g., from room to room), the speaker 105A, speaker 105B, and soundbar 103 can adjust audio playback to suit the user's location. Adjusting audio playback can include adjusting audio volume, ceasing to emit audio, commencing emitting audio, changing the audio that is emitted or the like. For example, if speaker 105A is in room A and speaker 105B is in room B, and user moves from room A to room B, speaker 105A can gradually decrease volume of audio playback as the user leaves room A until speaker 105A stop emitting audio altogether when user has left room A; and speaker 105B can commence emitting audio as user approaches room B (or leaves room A) and can gradually increase volume of audio playback until user has entered room B. The device environment 100 can dynamically adjusts audio playback based on user's location to reduce the user's perceived changes in audio as the user moves about the environment. The device environment 100 can emit different audio (e.g., volume or track) in different locations within an environment so that as the user moves about the environment that hear different audio. For example, speaker 105A can emit audio at a first volume in room A and speaker 105B can emit audio at a second volume in room B. As another example, speaker 105A can emit a first audio track in room A (e.g., a first song) and speaker 105B can emit a second audio track in room B (e.g., a second song).

The device environment 100 can generate alerts based on detecting suspicious activity. For example, sensors 107 (which can include cameras, position sensors, or the like) can monitor an environment and can generate an audible alert via speakers 105, a visual alert via display device 111, and/or can communicate a notification to user device 109 and/or remote server 113. Suspicious activity can include detecting an unfamiliar face (based on facial recognition), detecting an unfamiliar voice (based on voice recognition), detecting an intrusion within an environment. Suspicious activity can be based on detected audio volume. For example, loud sounds above a decibel threshold such as gunshots or breaking windows can be indicative of suspicious activity. The device environment 100 can detect suspicious activity based on implementing an artificial intelligence large language model to monitor conversations. For example, the device environment 100 can implement an AI LLM (e.g., executing on the remote server 113, soundbar 103, or other device) to monitor a conversation between a caregiver and an elderly person to determine a topic of conversation and whether the conversation is suspicious.

The device environment 100 can adjust audio playback (from the speakers 105 and/or soundbar 103) based on various factors individually or in combination, such as date, day of the week, time of day, user location, sensor data originating from sensors 107, physiological data of user, or the like. For example, the device environment 100 can adjust audio playback based on physiological data originating from sensors 107, such as heart rate, sleep state, respiration rate, etc. As another example, the device environment 100 can adjust audio playback based on environmental data originating from sensors 107, such as ambient temperature, ambient lighting, etc. Adjusting audio playback can include adjusting audio volume, turning audio on or off, adjusting audio track (e.g., changing songs or song genre), emitting an alert, and/or merely recommending adjusting audio playback without actually adjusting audio playback until further confirmation from user to adjust. As an example, the soundbar 103 can access physiological data of a user originating from sensors 107 and can play a song to match the user's heart rate (e.g., during a workout). As another example, the soundbar 103 can access physiological data of the user originating from sensors 107 indicating the user is asleep (such as respiration rate, motion data, heart rate, etc.) and can turn audio volume down or turn audio off to improve the user's sleep experience. As another example, the soundbar 103 can access physiological data of a user originating from sensors 107 indicating the user is in a dangerous physiological state (such as opioid overdose, hypoxia, cardiac arrythmias, etc.) and can generate audio alerts, such as loud audio sounds to warn the user or others that the user is in a dangerous state, or such as verbal instructions to instruct the user what to do (e.g., lie down, call 911, etc.). Soundbar 103 can verbally recite an indication of a user's physiological data, such as reciting their heart rate, SpO2, respiration rate, body temperature, etc (which may be based on physiological data originating from sensors 107).

The device environment 100 can adjust environmental conditions such as temperature or lighting level based on physiological data. For example, the soundbar 103 (or control device 101) can automatically adjust the temperature of the environment responsive to physiological data of the user originating from sensors 107. For example, responsive to physiological data indicating the user has a high skin temperature or core body temperature, the soundbar 103 can cause an air conditioner to turn on to decrease the environment temperature for the user. As another example, responsive to physiological data indicating the user is asleep (e.g., slowing respiration rate, slowing heart rate, decreased motion), the soundbar 103 can cause lights to turn off.

The device environment 100 can communicate physiological data. For example, the soundbar 103 (or control device 101) can communicate physiological data originating from the sensors 107 to the remote server 113 to be stored on the “cloud”, to allow a healthcare provider to access the physiological data, or for another purpose. The soundbar 103 can communicate physiological data to the remote server 113 periodically or in response to one or more conditions such as detection of a physiological condition. The sensors 107 can communicate physiological data to the user device 109 and/or to the soundbar 103 periodically or in response to one or more conditions.

The soundbar 103 can access physiological data from the remote server 113. For example, the soundbar 103 can retrieve a user's medical records from an EMR. As another example, the soundbar 103 can retrieve physiological data of the user or other medical data of the user when the user is discharged from a hospital.

The soundbar 103 can access data from the remote server 113 such as video data or audio data. The soundbar 103 can provide video data from the remote server 113 to the display device 111 to be displayed and/or can emit audio based on audio data from the remote server 113. For example, the soundbar 103 can access video data and/or audio data stored on a proprietary server (e.g., accessible via a subscription) and can provide that data to the display device 111 for displaying videos and/or can emit corresponding audio. Accordingly, a user may subscribe to a video streaming service or audio streaming service and can stream video content or audio content with the soundbar 103. The soundbar 103 can stream from restricted-access sources, as described, or from publicly available sources.

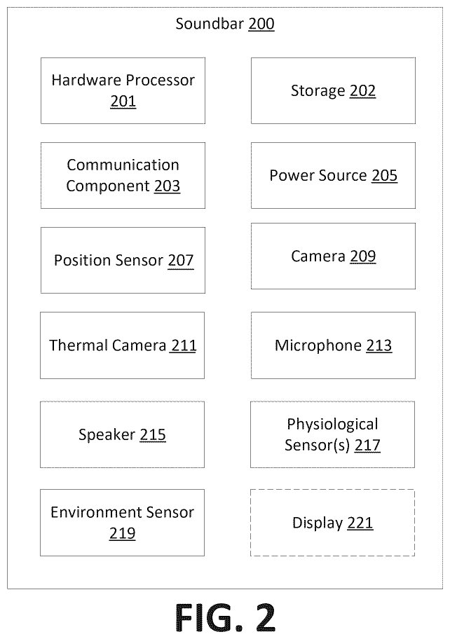

FIG. 2 is a block diagram illustrating an example implementation of a soundbar 200. Soundbar 200 can include similar structural and/or operational features as any of the other example soundbars shown and/or described herein. Soundbar 200 may also be referred to as an audio device. Soundbar 200 can include one or more hardware processors 201, a communication component 203, storage 204, power source 205, position sensor 207, camera 209, infrared camera 211, microphone 213, speaker 215, physiological sensors 217, and environment sensor 219. Any of the example components of soundbar 200 shown and/or described at FIG. 2 can be integrated within a same housing or may be integrated within separate housings such as distributed throughout a plurality of different devices within an environment.

The hardware processor 201 can comprise one or more integrated circuits. The hardware processor 201 may comprise and/or have access to memory. The hardware processor 201 may comprise and/or be embodied as one or more chips, controllers such as microcontrollers (MCUs), and/or microprocessors (MPUs). The hardware processor 201 may comprise a central processing unit (CPU). In some implementations, the hardware processor 201 may be embodied as a system-on-a-chip (SoC). The hardware processor 201 can be configured to implement an operating system which may allow multiple processes to execute simultaneously. The hardware processor 201 can be configured to execute program instructions to cause the soundbar 200 to perform one or more operations. The hardware processor 201 can be configured, among other things, to process data, execute instructions to perform one or more functions, and/or control the operation of the soundbar 200 or components thereof. For example, the hardware processor 201 can process data obtained from sensors and can execute instructions to perform functions related to storing and/or transmitting such data. In some implementations, the hardware processor 201 may be remote to the soundbar 200.

The storage 202 can include any computer readable storage medium and/or device (or collection of data storage mediums and/or devices), including, but not limited to, one or more memory devices that store data, including without limitation, dynamic and/or static random-access memory (RAM), programmable read-only memory (PROM), erasable programmable read-only memory (EPROM), electrically erasable programmable read-only memory (EEPROM), optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. The storage 202 can store data including processed and/or unprocessed physiological data obtained from physiological sensors and/or remote servers or computing devices. The storage 202 can store program instructions that when executed by the hardware processor 201 cause the soundbar 103 to perform one or more operations.

The communication component 203 can facilitate communication (via wireless, wired, and/or wire-like connection) between the soundbar 200 (and/or components thereof) and separate devices, such as separate monitoring hubs, monitoring devices, sensors, systems, servers, or the like. For example, the communication component 203 can be configured to allow the soundbar 200 to wirelessly communicate with other devices, systems, and/or networks over any of a variety of communication protocols, including near-field communication protocols and far-field communication protocols. Near-field communication protocols, which may also be referred to as non-radiative communication, can implement inductive coupling between coils of wire to transfer energy via magnetic fields (e.g., NFMI). Near-field communication protocols can implement capacitive coupling between conductive electrodes to transfer energy via electric fields. Far-field communication protocols, which may also be referred to as radiative communication, can transfer energy via electromagnetic radiation (e.g., radio waves). The communication component 203 can communicate via any variety of communication protocols such as Wi-Fi, Bluetooth®, ZigBee®, Z-wave®, cellular telephony such as long-term evolution (LTE) and/or (such as 1G, 2G, 3G, 4G, 5G, etc.), infrared, radio frequency identification (RFID), satellite transmission, inductive coupling, capacitive coupling, proprietary protocols, combinations of the same, and the like. In some implementations, communication component 203 can implement human body communication (HBC) which may include capacitively coupling a transmitter and receiver via an electric field propagating through the human body. The communication component 203 can allow data and/or instructions to be transmitted and/or received to and/or from the soundbar 200 and separate computing devices. The communication component 203 can be configured to transmit and/or receive (for example, wirelessly) processed and/or unprocessed physiological data with separate computing devices including physiological sensors, remote servers, or the like. In some implementations, communication component 203 can transfer power required for operation of a computing device. The communication component 203 can be embodied in one or more components that are in communication with each other. The communication component 203 can include one or more of: transceivers, antennas, transponders, radios, emitters, detectors, coils of wire (e.g., for inductive coupling), and/or electrodes (e.g., for capacitive coupling). The communication component 203 can include one or more integrated circuits, chips, controllers, processors, or the like, such as a Wi-Fi chip and/or a Bluetooth chip.

The power source 205 can provide power for components of the soundbar 200. The power source 205 can include a battery. In some implementations, the power source 205 may be external to the soundbar 200. For example, the soundbar 200 can include or can be configured to connect to a cable which can itself connect to an external power source to provide power to the soundbar 200. The power source 205 can include a dual-battery configuration with a main battery and a backup battery. The soundbar 200 can additionally or alternatively be configured to be solar-powered, for example, by including a solar panel on the dial or elsewhere of the soundbar 200.

The position sensor 207 can monitor positions of objects within an environment. The position sensor 207 can be a proximity sensor or motion sensor. The position sensor 207 can include a transmitter and a receiver configured to transmit and receive, respectively, electromagnetic radiation. The position sensor 207 can determine object positions based on emitting and/or detecting electromagnetic radiation, such as radio waves or microwaves. The position sensor 207 can be configured to emit and/or detect electromagnetic radiation between about 2 GHz to about 600 GHz, between about 3 GHz to about 300 GHZ, between about 3 GHz to about 10 GHz, between about 10 GHz to about 300 GHz, or between about 30 GHz to about 300 GHz. The position sensor 207 can be an ultra-wide band (UWB) sensor. The position sensor 207 can be a millimeter wave (mmWave) sensor. The position sensor 207 can advantageously monitor a user's position without obtaining sensitive information such as photo images of the user.

The camera 209 can capture images, such as of the user or the environment. The camera 209 can capture images of a specific portion of a user such as the user's eyes, a specific skin region, the user's hair, the user's nails, the user's ears, the user's mouth, etc. The camera 209 can generate image data in response to detecting visible light. The camera 209 can generate video image data. The camera 209 can capture images periodically, in response to motion, or on command. The soundbar 200 can include a plurality of cameras 209. The camera 209 can be a 3D camera, a depth camera, or a stereovision camera. The soundbar 200 (e.g., hardware processor 201) can implement imaging processing techniques, such as pattern recognition, color recognition, or facial recognition, on image data generated by the camera 209.

The hardware processor 201 can access image data originating from the camera 209 and can process the image data. The hardware processor 201 can determine one or more physiological conditions of a user from the image data. For example, the hardware processor 201 can determine a skin condition of the user (such as psoriasis, eczema, a rash, a burn, sun spots, infections) based on images of the user's skin. As other examples, the hardware processor 201 can determine a hair condition based on images of a user's hair or scalp, or can determine another physiological condition based on images of the user's nails, the user's ear, the user's mouth (e.g., gums, teeth, tonsils, tongue), or the user's eyes. Eye conditions can include styes, dry eyes, infections, allergies, conjunctivitis, blepharitis, and subconjunctival hemorrhages. The hardware processors 201 can generate alerts to notify the user to undergo periodic image screenings to capture images of the user for physiological analysis. The hardware processor 201 can generate a medication protocol, a dietary protocol, a healthcare protocol, a recommended procedure, a recommendation to visit a healthcare specialist based on analyzing image data from the camera 209.

The hardware processor 201 can communicate camera image data to a remote device or server (e.g., via the communication component 203) for remote processing and/or analysis. The hardware processor 201 can communicate camera image data to a remote device or server during a live-stream video call, such as with a health care provider. For example, during a virtual visit with a healthcare provider (such as a dermatologist, ophthalmologist, dentist, otolaryngologist), the hardware processor 201 can communicate image data of the user originating from the camera 209 in real-time to the healthcare provider's device for the healthcare provider to view, analyze, and diagnose. The hardware processor 201 can communicate camera image data (or other health-related data) to a remote device or server automatically upon detection of a condition. For example, the hardware processor 201 can automatically communicate images to a remote device of a healthcare provider automatically upon detecting a particular health condition from the images for confirmation or further analysis by the healthcare provider.

The camera 209 may be a retinal camera configured to image the inner portions of user's eye including the retina and rear portions of a user's eye (e.g., fundus photography). The hardware processor 201 can process the camera image data to determine a user's level of diabetic retinopathy (DR) or retinopathy of prematurity (ROP). In some implementations, the camera 209 (and hardware processor 201) can implement ocular tonometry.

The hardware processor 201 can feed image data (or other data) to an artificial intelligence system which may be local or remote to the soundbar 200. For example, the hardware processor 201 may implement machine learning on camera image data to determine physiological conditions of the user. For example, the hardware processor 201 can access a dataset of images (from a remote source and/or stored locally) which may correspond to a plurality of users and which may have an analysis/diagnosis associated with the images. The hardware processor 201 can then generate an analysis/diagnosis for the user's images based on matching the user's images to the images of the dataset. For example, if the user's image of their skin most closely matches an image from a dataset with a known diagnosis (e.g., skin infection), the hardware processor 201 can generate an analysis that the user has the same skin infection condition. Machine learning techniques can include pattern recognition to diagnose skin conditions, such as rashes, burns, infections, eye conditions, fall detections to identify when a user has fallen or to assess the severity of a fall. In some implementations, the hardware processor 201 can communicate the camera image data (via the communication component 203) to a remote server or system implementing machine learning and can receive data from the remote server or system implementing the machine learning. In some implementations, the hardware processor 201 (or machine learning model) can generate an analysis based on location. For example, if a user is in a location of the world associated with particular diseases, the hardware processor 201 may bias an analysis to those region-specific diseases and/or a machine learning model may access datasets associated with that location for performing analysis.

The thermal camera 211 can be a thermal imager responsive to thermal energy. The thermal camera 211 can be an infrared (IR) camera that can detect infrared radiation which can indicate thermal energy. The thermal camera 211 can generate thermal image data which can comprise image data and temperature data. For example, the thermal camera 211 can generate data indicating the temperature of various portions of an environment or a user.

The microphone 213 can generate audio data responsive to detecting audio. The microphone 213 can comprise a plurality of ports or openings for detecting audio. The microphone 213 may be a directional microphone. The soundbar 200 can include a plurality of microphones 213. The hardware processor 201 can cause the soundbar 200 to perform operations based on audio detected by microphone 213 (e.g., verbal commands) which can be processed and deciphered by the hardware processor 201.

The speaker 215 can emit audio including songs, alerts, notifications, instructions, voice-call audio, or the like. The speaker 215 can emit audio based on data originating from the hardware processor 201, the storage 202, and/or the communication component 203. The soundbar 200 can comprise a plurality of speakers 215. The speaker 215 can include a tweeter, and/or a woofer. The speaker 215 can emit audio in a particular direction. For example, the soundbar 200 can include one or more directional speakers 215 for implementing certain audio effects such as surround sound.

The physiological sensors 217 can generate physiological data corresponding to physiological parameters. The physiological sensors 217 can include one or more of acoustic sensors, optical sensors, inertial sensors, temperatures sensors, electrical sensors, voltage sensors, impedance sensors, etc. The physiological sensors 217 can include an oximeter. The physiological sensors 217 can include a photoplethysmography (PPG) sensor configured to measure volumetric variation in blood circulation and derive one or more parameters therefrom, such as pulse rate, blood pressure, respiration rate, cardiac output, perfusion index, pleth variability index, PPG waveform data, blood oxygen saturation, etc. The physiological sensors 217 can include one or more optical emitters configured to emit optical radiation of a plurality of wavelengths, which may include visible light. The physiological sensors 217 can include one or more optical detectors configured to detect optical radiation attenuated by the tissue of subject (which may have been emitted by optical emitters) and generate data relating to the pulsatile characteristics of the subject, including blood oxygen saturation, hydration, hemoglobin content, etc. The physiological sensors 217 can include electrocardiogram (ECG) sensors, including one or more electrodes, configured to measure electrical activity of the subject, such as cardiac signals. The physiological sensors 217 can measure and/or generate data relating to respiration rate, blood oxygen saturation (e.g., SpO2), heart rate, pulse rate, skin temperature, core body temperature, spatial orientation, or the like.

The environment sensor 219 can measure one or more aspects of an environment such as air quality (for example, carbon monoxide levels, smoke levels, particulate matter levels, volatile organic compound (VOC) levels, nitrogen dioxide levels, etc.), humidity, environment temperature, and/or ambient light. The environment sensor 219 can include one or more of a carbon monoxide detector, smoke detector, hygrometer, temperature sensor, light sensor, or the like. The environment sensors 219 can generate data relating to the environment. The hardware processor 201 can access data originating from the environment sensor 219 and can cause the soundbar 200 to perform one or more operations response to the environment data. For example, the soundbar 200 can emit an audio alert response to detecting that an air quality of the environment is poor or dangerous (e.g., high carbon monoxide levels, high particulate matter levels, etc.). As another example, the soundbar 200 can generate and communicate data to a separate display device for the display device to display a visual alert. As another example, the soundbar 200 can generate and communicate instructions to a separate device, such as an air purifier, to perform one or operations based on the environment data (e.g., turn the air purifier on if particulate matter level is high).

The soundbar 200 can optionally include a display 221 in some implementations. The display 221 can be integrated within the same housing as soundbar 200 or can be remote to the soundbar 200. The display 221 can display user interfaces, such as any of the example user interfaces, or aspects thereof, that are shown and/or described herein. The display 221 can include an LED screen, an LCD screen, an OLED screen, a QLED screen, a plasma display screen, a quantum dot display screen, or the like. The display 221 may be responsive to touch. For example, the display screen may comprise a touchscreen such as a resistive touchscreen, a capacitive touchscreen, an infrared touchscreen, a surface acoustic wave touchscreen, or the like. The display 221 can display user interfaces based on data originating from hardware processor 201, storage 202, and/or communication component 203.

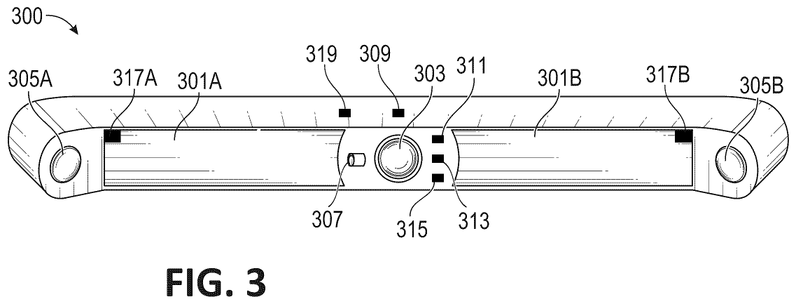

FIG. 3 shows an example soundbar 300. Soundbar 300 can include any of the structural and/or operational features of any of the other example soundbars shown and/or described herein. Soundbar 300 can also be referred to as an audio device. The soundbar 300 can include speakers 301A, 301B, camera 303, cameras 305A, 305B, privacy switch 307, physiological sensor 309, position sensor 311, near-field communication (NFC) reader 313, thermal camera 315, microphones 317A, 317B, and environment sensor 319.

The speakers 301A, 301B can include speaker arrays. The speakers 301A, 301B may be positioned on opposite sides of the soundbar 300. The speakers 301A, 301B can emit stereo audio (e.g., left audio and right audio). The speakers 301A, 301B can include tweeters and/or woofers.

The camera 303 can capture images. The camera 303 can be the primary camera of the soundbar 300. The camera 303 can track a person of interest such as a person talking. The camera 303 can move relative to the soundbar 300. For example, the camera 303 can pan, tilt, pivot, swivel, or rotate relative to the soundbar 300 such as when tracking on object of interest. The camera 303 can optically zoom on an object of interest such as a person talking. The camera 303 can be a Pan-Tilt-Zoom (PTZ) camera.

The cameras 305A, 305B can be positioned on opposite sides of the soundbar 300. The cameras 305A, 305B may be positioned on the soundbar 300 to be oriented to be facing inward toward each other. In some implementations, the cameras 305A, 305B may be positioned on the soundbar 300 to be oriented to be facing away from each other. The 305A, and 305B may face in different directions from each other and/or from camera 303. A field of view of the camera 303 and the cameras 305A, 305B may intersect. The cameras 303, 305A, and 305B may provide stereo vision of the environment. The soundbar 300 can process image data from camera 303 in combination with image data from cameras 305A, 305B to generate a panoramic image of the environment.

The privacy switch 307 may be a mechanically actuated component disposed on a surface of the soundbar 300. The privacy switch 307 can be actuated by a user. The privacy switch 307 may be able to physically move relative to the soundbar 300. Actuating the privacy switch can include sliding the privacy switch 307. In some implementations, the privacy switch 307 may be a button that can be pressed by a user. Actuating the privacy switch 305 can cause the soundbar 300 to implement a privacy mode which can include disabling one or more components of the soundbar 300 such as a camera or a microphone. In some implementations, implementing a privacy mode can disable the soundbar 300 from communicating with other devices such as by disabling communication components of the soundbar 300. Disabling components during a privacy mode can include removing the components from power (while allowing other components to continue to receive power to continue to operate).

The physiological sensor 309 can include an oximeter configured to implement photoplethysmography (PPG) to measure volumetric variation in blood circulation and derive one or more parameters therefrom, such as pulse rate, blood pressure, respiration rate, cardiac output, perfusion index, pleth variability index, PPG waveform data, blood oxygen saturation, etc. The physiological sensor 309 can include one or more optical emitters configured to emit optical radiation of a plurality of wavelengths, which may include visible light. The physiological sensor 309 can include one or more optical detectors configured to detect optical radiation attenuated by the tissue of subject (which may have been emitted by optical emitters) and generate data relating to the pulsatile characteristics of the subject, including blood oxygen saturation, hydration, hemoglobin content, etc. The physiological sensor 309 can be disposed on a surface of the soundbar 300 (such as a top facing surface) and can be implemented as a transreflectance sensor. For example, a user may place their finger on the physiological sensor 309 on the surface of the soundbar 300 to perform a physiological measurement. The physiological sensor 309 can include electrocardiogram (ECG) sensors, including one or more electrodes, configured to measure electrical activity of the subject, such as cardiac signals.

The position sensor 311 can monitor a position of objects in an environment in front of the soundbar 300. The position sensor 311 can be a proximity sensor or motion sensor. The position sensor 311 can be an ultra-wide band (UWB) sensor and/or a millimeter wave (mmWave) sensor. The position sensor 311 can advantageously monitor a user's position without obtaining sensitive information such as images of the user.

The NFC reader 313 can comprise inductive coils to transfer data via magnetic fields (e.g., NFMI) to and from inductively coupled coils in a separate device. For example, a user may position a device such as a phone adjacent to the NFC reader 313 to inductively couple the NFC reader 313 with the device to transfer data therebetween. Transferring data with NFC reader 313 can include verifying a user's identity to authorize the user to use the soundbar 300.

The thermal camera 315 can be an infrared (IR) camera configured to detect infrared radiation to generate thermal data of a user or an environment.

The microphones 317A, 317B can be positioned on opposite sides of the soundbar 300. The microphones 317A, 317B can detect stereo audio (e.g., left audio and right audio).

The environment sensor 319 can be positioned on a surface of the soundbar 300 such as a top facing surface. The environment sensor 319 can measure one or more aspects of an environment such as air quality, carbon monoxide levels, smoke levels, particulate matter levels, volatile organic compound (VOC) levels, nitrogen dioxide levels, humidity, temperature, and/or ambient light. The environment sensor 319 can include one or more of a carbon monoxide detector, smoke detector, hygrometer, temperature sensor, light sensor, or the like.

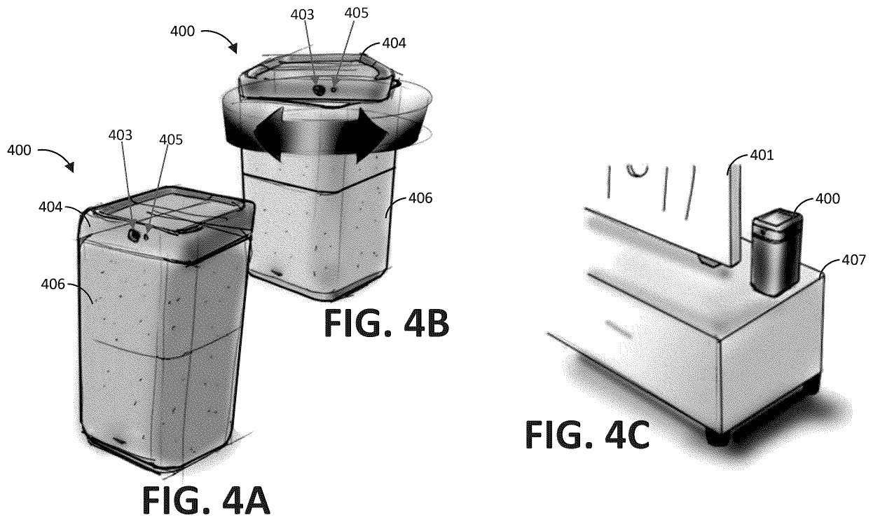

FIGS. 4A-4C illustrate example implementations of an audio device 400 which can include similar structural and/or operational features as any of the other example audio devices or soundbars shown and/or described herein. Audio device 400 can include a swivel portion 404 and a base portion 406. The base portion 406 can comprise one or more speakers which may extend along the base portion 406 from a bottom region of the audio device 400 to the swivel portion 404 at the top region of the audio device 400. In some implementations, a plurality of speakers may be positioned on top of each other within the base portion 406. The swivel portion 404 can include a camera 403 and a sensor 405 which may be a proximity sensor, a motion sensor, a temperature sensor, a microphone or any of the other example sensors shown and/or described herein. The camera 403 and the sensor 405 can be oriented in a same direction and may be positioned on a same side or surface of swivel portion 404, as shown. In some implementations, the camera 430 and the sensor 405 can be positioned on different sides or surfaces of the swivel portion 404 and/or may be facing different directions.

The swivel portion 404 can rotate relative to the base portion 406 as shown in FIG. 4B for example. The swivel portion 404 can rotate based on image data generated by a camera and audio data generated by a microphone. For example, the swivel portion 404 can rotate to allow camera 403 to capture images of a user based on tracking the user's location from image data and/or from audio data. The swivel portion 404 can automatically rotate and/or can rotate in response to user commands. The swivel portion 404 can rotate 360 degrees. In some implementations, the swivel portion 404 can rotate indefinitely in one direction (e.g., more than 360 degrees). The swivel portion 404 can rotate within a plane parallel to a surface on which the audio device 400 rests.

FIG. 4C illustrates audio device 400 positioned on a surface 407 adjacent to a display device 401. The display device 401 can display images based on image data originating from camera 403.

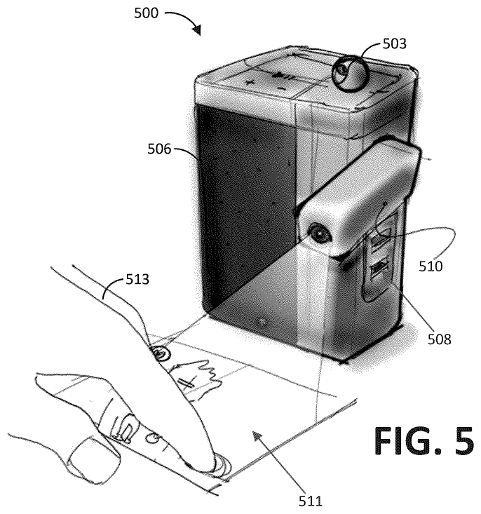

FIG. 5 illustrates an example implementation of an audio device 500 which can include similar structural and/or operational features as any of the other example audio devices or soundbars shown and/or described herein. Audio device 500 can include a camera 503, a speaker 506, a projector 510, and electronic ports 508.

The electronic ports 508 can receive cables such as USB cables or power cords. The electronic ports can transmit data to and/or from the audio device 500. The electronic ports 508 can transmit power to the soundbar to power operation of the audio device 500 or may transmit power stored in the audio device 500 to other devices.

The camera 503 may be positioned on a top surface of the audio device 500. The camera 503 can rotate and/or swivel in a plurality of directions. The camera 503 may be a Pan-Tilt-Zoom (PTZ) camera. The camera 503 can move relative to the audio device 500 to track an object of interest. The camera 503 can move automatically and/or in response to user command.

The speaker 506 can emit audio. The speaker 506 can be positioned at a bottom portion of the audio device 500. The speaker 506 can extend from a bottom surface of the audio device 500 to a top region of the audio device 500.

The projector 510 can be positioned on a side of the audio device 500. The projector 510 can rotate relative to the audio device 500. The projector 510 can rotate within a plane that is orthogonal to a surface on which the audio device 500 rests. The projector 510 can project images 511 onto a surface. The projector 510 and/or camera 503 can track movements of a user 515 (e.g., a user's finger) to determine where the user 515 touches on the projected image 511. In response to a user's 515 interaction with the projected image 511, the projector 510 can update the projected image 511. Accordingly, the projected image 511 may operate like an interactive touchscreen display. The projector 510 can project images 511 based on image data originating from camera 503, stored locally on the audio device 500, and/or received from a remote device or server.

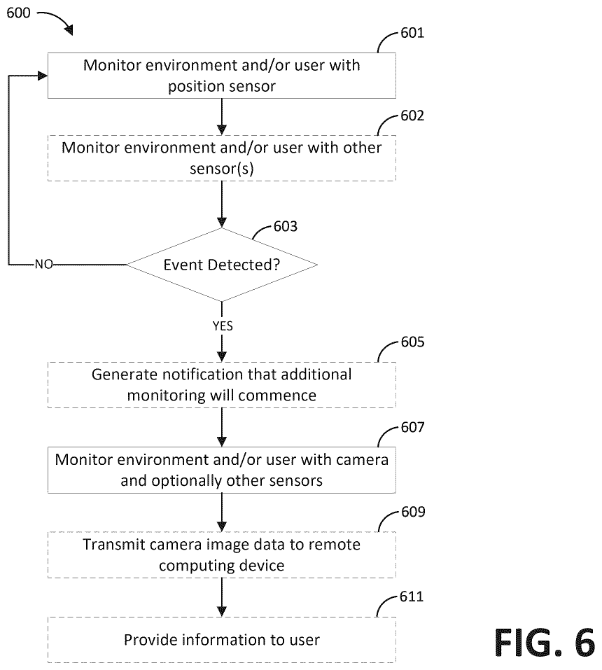

FIG. 6 is a flowchart illustrating an example process 600 for monitoring a user's position. This process, in full or parts, can be executed by one or more hardware processors, whether they are associated with a singular computing device, multiple computing devices, and even devices in remote or wireless communication. By way of example, the one or more hardware processors executing process 600 can be associated with any of the example soundbars or other devices shown and/or described herein. The implementations of this process may vary and can involve modifications like omitting blocks, adding blocks, and/or rearranging the order of execution of the blocks. Process 600 serves as an example and is not intended to restrict the present disclosure.

At block 601, the process 600 can monitor an environment and/or user with one or more position sensors. A position sensor can be a UWB sensor and/or a mmWave sensor. Position sensors can be integrated within a soundbar. Position sensors can be integrated within a plurality of devices distributed throughout an environment. Positions sensors can generate data relating to position or location of user within an environment.

At block 602, the process 600 can optionally monitor the environment and/or user with one or more other sensors which may be integrated within a soundbar, distributed through the environment, and/or coupled to the user. For example, the soundbar can access physiological data originating from a wearable device coupled to the user. Additional examples of sensors, include microphones, temperature sensor, and environment sensors which may be integrated within the soundbar. In some implementations, the process 600 may only monitor data that is agnostic to the user to preserve the user's privacy. For example, the process 600 may monitor environment temperature but may not monitor user's physiological data. Examples of user agnostic data include, environment temperature, air quality, ambient lighting conditions, or other environmental conditions detected by an environment sensor, time of day, etc. In some cases, user agnostic data can include audio data originating from a microphone or motion data originating from an inertial sensor connected to a user.

At decision block 603, the process 600 can determine whether an event has been detected. Example events include the presence (or absence) of a user within an environment such as when a user enters or leaves a room being monitored by position sensors. Another example event can be a user experiencing a fall, such as if the user falls to the ground. Other example events can include changes in breathing as determined by changes in positions of a chest cavity of a user indicative of lung activity. Advantageoulsy, position sensors such as UWB and/or mmWave sensors can detect small changes in position such as the small changes in a person's chest resulting from inhaling and exhaling. The event can be referred to as an adverse event and can correspond to physiological distress of the user. In some implementations, the process 600 can register that an event has been detected if the health or safety of the user outweighs the user's privacy. The process 600 can implement machine learning to determine whether an event has occurred (e.g., a fall, apnea, etc). For example, the process 600 can access a dataset comprising fall information that has been characterized (e.g., by fall type, by fall severity, by fall confirmation, length of fall) and can compare position sensor data to the dataset to determine whether a fall has occurred, the type of fall, and/or a severity of the fall. If an event is not detected, the process can return to block 601. If an event is detected, the process 600 can proceed to block 605.

In some implementations, the process 600 detects an event from only position sensor data. In some implementations, the process 600 detects an event from position sensor data in combination with other sensor data such as from block 602. For example, the process 600 can detect an event if the position sensor data indicates the user has fallen and other sensors indicate another condition such as the environment temperature exceeding a threshold, the user calling for help detected by microphones, slurred speech detected by microphone and analyzed by processor, the user's heart rate exceeding a threshold as monitored by physiological sensors, etc. Detecting an event can depend on the time of day. For example, the process 600 may detect an event upon occurrence of certain conditions at one time of day but may not register the event as being “detected” upon occurrence of those same conditions at a different time of day. Detecting an event can depend upon the length of time which certain conditions persist. For example, process 600 can initiate a timer upon occurrence of certain conditions and may only register the event as being “detected” if those conditions persist in excess of a certain time threshold. For example, the process 600 may only detect an event if a user falls and remains on the ground for more than 10 seconds, more than 30 seconds, more than a minute, etc. As another example, the process 600 may only detect an event if a user experiences apnea for longer than 30 seconds, a minute, etc. In some implementations, the time threshold is dynamically adjustable based on gathered data specific to the environment and/or user, and/or the time threshold may be manually adjusted by a user and/or remote healthcare provider. As described in any of the preceding examples, the process 600 can determine an event has occurred if the safety or health of the user outweighs the user's privacy. The health or safety can be determined based on one or more of length of time of an event, physiological data from a sensor attached to the user, supplement data from other sensors, time of day, etc. The threshold against which to weigh the user's privacy can be dynamically adjusted by a user. For example, a user (or healthcare provider) may be able to adjust a length of time that apnea can be detected by position sensor data before registering that an adverse event has occurred.

At block 605, the process 600 can optionally generate a notification that additional monitoring will commence of the environment and/or the user. Additional monitoring can include capturing images with a camera. Generating a notification can include generating an audio alert, such as a sound or verbal indication, via a speaker. Generating a notification can include generating a visual alert via a display. Advantageously, additional monitoring may not begin until a notification has been generated which may ensure that a user's privacy is protected. In some implementations, a user may override the additional monitoring such as by a verbal command or a presetting.

At block 607, the process 600 can implement additional monitoring such as by causing the camera to monitor the environment and/or the user. In some implementations, causing the camera to monitor the environment can include removing a cover from a lens, turning the camera on, or switching the camera to a monitor mode from a standby mode (which may include being off) which the camera may use to save power. The process 600 can monitor the environment to detect, monitor, and/or confirm the presence of an event with image data generated by the camera and/or may verify the occurrence of the event detected at block 603 with the position sensor. For example, if at block 603, the process 600 determines that a user has entered an environment with the position sensor data, then at block 607 the process 600 can determine whether a fall is detected with the image data from the camera. As another example, if at block 603, the process 600 determines that a user has fallen with the position sensor data, then at block 607 the process 600 can verify that the user has actually fallen with the image data from the camera.

Monitoring the environment and/or user can include implementing facial recognition or other image processing techniques. For example, upon detecting a user entering the environment the process 600 can implement facial recognition to verify the identity of the user to prevent intruders, which may be particularly useful for certain times of day (e.g., at night, during a user's normal work hours when the user is typically not home, etc). Implementing additional monitoring at block 607 can optionally include monitoring with sensors other than the camera, such as physiological sensors or environment sensors.

Implementing additional monitoring with the camera at block 607 can include using historical image data generated by the camera prior to initiation of block 605 and/or block 607, or even block 603. For example, prior to monitoring the environment at block 607, the camera may be in a standby mode (e.g., a non-monitoring mode) wherein the camera can capture images and/or generate image data to store in a buffer (e.g., in non-persistent memory). The buffer can store camera image data for a period of time such as between 0.5 seconds and 1.0 second, between 1 second and 5 seconds, between 1 second and 10 seconds, between 1 second and 15 seconds, between 1 second and 30 seconds, between 1 second and 60 seconds, or any other range of time, before deleting the camera image data. Accordingly, the buffer may continuously store certain time period's worth of image data from the camera before deleting the image data. When an event is detected at block 603, such as a fall, the process 600 can automatically transition the camera between modes (including changing the buffer's operation) such as by causing the buffer to stop deleting data, prolonging the time the buffer stores the data before deleting the data, and/or causing the buffer to store its data in long term storage, such as persistent memory. Thus, the buffer may comprise camera image data corresponding to a time frame wherein the event was detected. Thus, the process 600 may be able to access camera image data corresponding to when the event occurred and can analyze said camera image data (e.g., at block 607) to verify the occurrence of the event from block 603 and/or to monitor for the occurrence of other events. Accordingly, implementing a buffer may preserve a user's privacy while not sacrificing potentially useful data.

At block 609, the process 600 can optionally transmit camera image data (or other sensor data) to a remote computing device, which may be a server. Transmitting the camera image data to a remote device can allow a remote person to view images of the user and/or environment. For example, if the user has experienced a fall, then a remote person can view the person and can determine whether the user is in danger and needs assistance. As another example, if the process 600 detects the unsuspected presence of a person at block 603 within the environment, the process 600 can transmit the camera image data to a remote person to verify that the detected person is authorized to be in the environment (e.g., verify an intruder in a home, or verify presence of persons within a hospital room).

At block 611, the process 600 can optionally provide information to the user. The process 600 can provide the information in response to detecting the user's presence within the environment at block 603. The information can be health related such as reminder to take prescribed medication. The process 600 can provide visual information via a display device. The process 600 can provide auditory information via a speaker, which can include verbal instructions to aid the user.

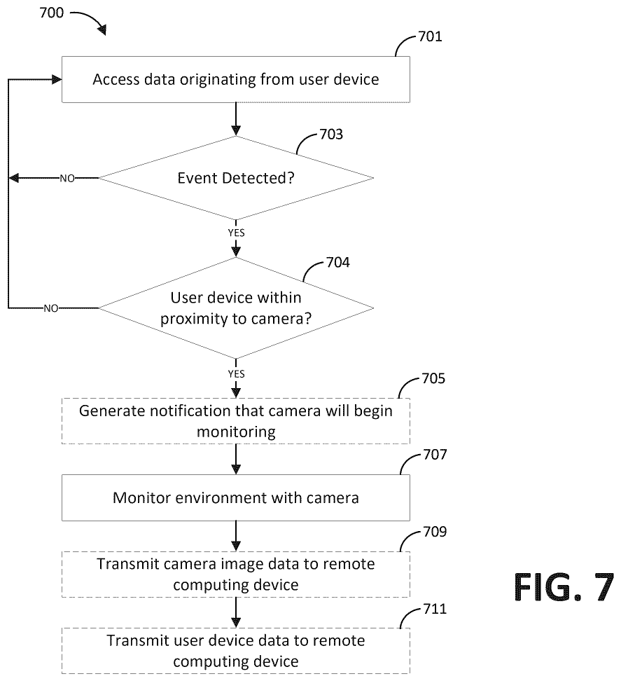

FIG. 7 is a flowchart illustrating an example process 700 for monitoring a user's position. This process, in full or parts, can be executed by one or more hardware processors, whether they are associated with a singular computing device or multiple computing devices, and even devices in remote or wireless communication. By way of example, the one or more hardware processors executing process 700 can be associated with any of the example soundbars or other devices shown and/or described herein. The implementations of this process may vary and can involve modifications like omitting blocks, adding blocks, and/or rearranging the order of execution of the blocks. Process 700 serves as an example and is not intended to restrict the present disclosure. Aspects of process 700 can be combined with aspects of process 600 and/or vice versa.

At block 701, the process 700 can access data originating from a user device. The user device can be a smartphone, smartwatch, auricular device, or the like. The user device can be a wearable device. The user device may comprise one or more physiological sensors, such as an inertial sensor (e.g., accelerometer or gyroscope), an oximeter, an ECG sensor, or the like. The data originating from the user device can include physiological data indicative of a physiological status of the user. The data originating from the user device can include motion data indicative of a motion of the user, such as linear acceleration data and/or angular velocity data. The data can be processed data or raw data. The data can include physiological parameters. The data can include an indication of detected events, such as physiological events or fall events.

At decision block 703, the process 700 can determine whether an event has occurred. An event may be a physiological event such as physiological parameter exceeding a threshold (e.g., low SpO2), a cardiac arrhythmia, a heart attack, an abnormal respiration rate, or the like. An event may be a fall detection such as if the user has fallen. In some implementations, the process 700 can analyze data originating from the user device (e.g., motion data) to determine whether an event has occurred (e.g., a fall). In some implementations, the user device may analyze data to determine whether an event has occurred an may communicate the detection of said event to the computing device. Accordingly, in some aspects, determining whether an event has occurred may include receiving an indication from the user device that the event has occurred. If the process 600 determines that the event has not occurred, the process can return to block 701. If the process 700 determines that the event has occurred, the process can proceed to block 704.

At decision block 704, the process 700 can determine whether the user device is in proximity to a camera. Determining that the user device is in proximity to the camera can include determining that the user device is in a view of the camera, within a certain distance of the camera, in a same environment as the camera, or the like. The process 700 can determine a location of the user device based on data from the user device including GPS data and/or wireless signal strength from the user device. The location of the camera may be known to the process 700 as a predetermined constant. The location of the user device and the user may be assumed to be same or similar. If a user device is outside of a proximity of the camera (e.g., in a different room), monitoring the environment with the camera may not result in monitoring the user if the user cannot be viewed by the camera. In such instance, preventing the camera from monitoring the environment can preserve energy and/or data storage space that might otherwise be wasted. If the process 700 determines that the user device is not in proximity to the camera, the process can return to block 701. If the process 700 determines that the user device is in proximity to the camera, the process can proceed to block 705.

At block 705, the process 700 can optionally generate a notification that a camera will begin monitoring the environment and/or the user. Generating a notification can include generating an audio alert, such as a sound or verbal indication, via a speaker. Generating a notification can include generating a visual alert via a display. Generating a notification can include communicating a signal to the user device for the user device to effectuate the notification (e.g., visual and/or auditory alert). Advantageously, the camera may not begin capturing images until a notification has been generated which may ensure that a user's privacy is protected. In some implementations, a user may override the camera from monitoring such as by a verbal command.

At block 707, the process 700 can cause the camera to monitor the environment and/or the user. In some implementations, causing the camera to monitor the environment can include turning the camera on or switching the camera from a standby mode which the camera may use to save power. The process 700 can monitor the environment to detect the presence of an event with image data generated by the camera and/or may verify the occurrence of the event detected at block 703. For example, if at block 703, the process 700 determines that a user has fallen with the user device data, then at block 707 the process can verify that the user has actually fallen with the image data from the camera.

Initiating monitoring the environment with the camera at block 707 can include using historical image data generated by the camera prior to any of blocks 707, block 705, block 704, or block 703. For example, prior to monitoring the environment at block 707, the camera may be in a standby mode (e.g., a non-monitoring mode) wherein the camera can capture images and/or generate image data to store in a buffer (e.g., in non-persistent memory). The buffer can store camera image data for a period of time such as between 0.5 seconds and 1.0 second, between 1 second and 5 seconds, between 1 second and 10 seconds, between 1 second and 15 seconds, between 1 second and 30 seconds, between 1 second and 60 seconds, or any other range of time, before deleting the camera image data. Accordingly, the buffer may continuously store a certain time period's worth of image data from the camera before deleting the image data. When an event is detected at block 703, such as a fall, the buffer may stop deleting data. Thus, the buffer may comprise camera image data corresponding to a time frame wherein the event was detected. Thus, the process 700 may be able to access camera image data corresponding to when the event occurred and can analyze said camera image data (e.g., at block 707) to verify the occurrence of the event from block 703 and/or to monitor for the occurrence of other events. Accordingly, implementing a buffer may preserve a user's privacy while not sacrificing potentially useful data.

At block 709, the process 700 can optionally transmit camera image data to a remote computing device, which may be a server. Transmitting the camera image data to a remote device can allow a remote person to view images of the user and/or environment. For example, if the user has experienced a fall, then a remote person can view the person and can determine whether the user is in danger and needs assistance. As another example, if the process 700 determines that the user has or is experiencing abnormal physiological conditions, such as abnormal cardiac activity, abnormal blood oxygen levels, abnormal respiration rate, etc., then the process 700 transmits camera image data of the user to a remote person (e.g., a healthcare provide or emergency contact) for the remote person to verify the status of the user and to determine whether any action should be taken to assist the user.

At block 711, the process 700 can optionally transmit user device data to a remote computing device, which may be a server. The user device data can include any of the example types of data described at block 701, such as physiological data and/or motion data. Transmitting user device data (e.g., physiological data) to a remote device can allow a remote person to continuously monitor the physiological status of the user in real-time during a potentially dangerous situation for the user.

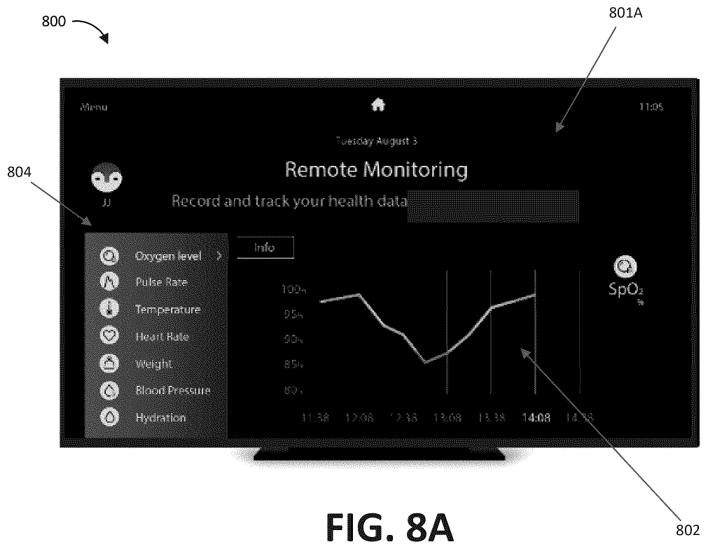

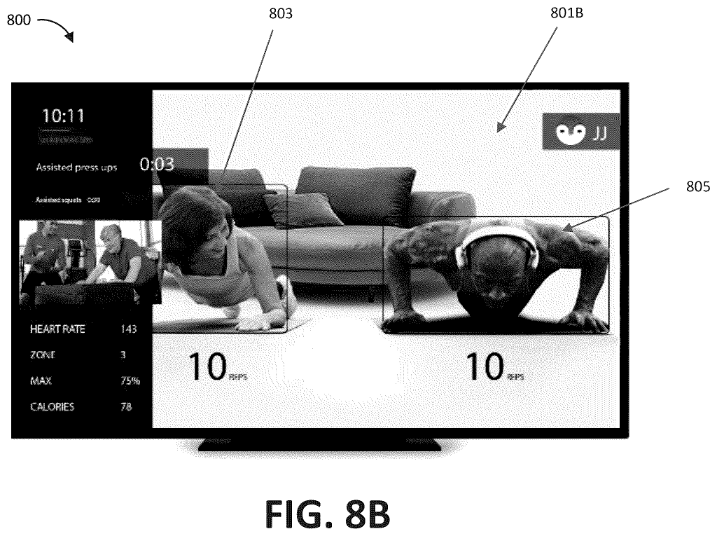

FIG. 8A illustrates an example display device 800 displaying user interface 801A. The user interface 801A can include indicia of physiological data of a user. For example, the user interface 801A can display a trend line 802 of physiological data such as SpO2. The user interface 801A can include a selectable menu 804 of options for displaying various physiological parameters such as oxygen level (e.g., SpO2), pulse rate, temperature, heart rate, weight, blood pressure, and hydration.

FIG. 8B illustrates another example user interface 801B displayed within display device 800. User interface 801B can include images originating from a camera associated with the display device 800. User interface 801B can include an image of user 803 (e.g., in real-time). User interface 801B can include an image of an avatar 805 overlaid on an image originating from a camera. Accordingly, the user interface 801B may combine images originating from cameras with computer generated images to produce an augmented reality image. For example, the avatar 805 may be computer generated and overlaid on an image from the camera comprising the user 803 to generate the appearance that the avatar is in the same environment as the user 803. In the example shown, the user 803 performs a workout routine while the user interface 801B displays real-time images of the user 803 so that the user can view their physical form and the user interface 801B also displays an avatar 805 to provide the appearance as if the avatar 805 were actually adjacent to the user 803 and performing the same workout routine with the user 803. The avatar 805 can provide instructions to the user 803 and the avatar 805 can dynamically update based on motion of the user 803. For example, if the user 803 stops moving, the avatar 805 can stop moving.

### Additional Considerations

While certain implementations have been described from the perspective of a soundbar, such as soundbar 103, any other audiovisual device can be used in addition to or in place of the soundbar.

Certain categories of persons, such as caregivers, clinicians, doctors, nurses, and friends and family of a user, may be used interchangeably to describe a person providing care to the user. Furthermore, patients or users used herein interchangeably refer to a person who is wearing a sensor or is connected to a sensor or whose measurements are used to determine a physiological parameter or a condition. Parameters may be, be associated with, and/or be represented by, measured values, display icons, alphanumeric characters, graphs, gages, power bars, trends, or combinations. Real time data may correspond to active monitoring of a user, however, such real time data may not be synchronous to an actual physiological state at a particular moment. Measurement value(s) of a parameter and the parameter used herein such as, SpO2, RR, PaO2 and the like, unless specifically stated otherwise, or otherwise understood with the context as used is generally intended to convey a measurement or determination that is responsive to the physiological parameter.

Although certain implementations and examples have been described herein, it will be understood by those skilled in the art that many aspects of the systems and devices shown and described in the present disclosure may be differently combined and/or modified to form still further implementations or acceptable examples. All such modifications and variations are intended to be included herein within the scope of this disclosure. A wide variety of designs and approaches are possible. No feature, structure, or step disclosed herein is essential or indispensable. The various features and processes described herein may be used independently of one another, or may be combined in various ways. For example, elements may be added to, removed from, or rearranged compared to the disclosed example implementations. All possible combinations and sub-combinations are intended to fall within the scope of this disclosure.

Any methods and processes described herein are not limited to any particular sequence, and the blocks or states relating thereto can be performed in other sequences that are appropriate. For example, described blocks or states may be performed in an order other than that specifically disclosed, or multiple blocks or states may be combined in a single block or state, or certain method or process blocks may be omitted, or certain blocks or states may be performed in a reverse order from what is shown and/or described. The example blocks or states may be performed in serial, in parallel, or in some other manner. Blocks or states may be added to or removed from the disclosed example implementations.

The methods disclosed herein may include certain actions taken by a practitioner; however, they can also include any third-party instruction of those actions, either expressly or by implication.

The methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. The computer system may be a cloud-based computing system whose processing resources are shared by multiple distinct entities or other users. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames).

Many other variations than those described herein will be apparent from this disclosure. For example, depending on the implementation, certain acts, events, or functions of any of the algorithms described herein can be performed in a different sequence, can be added, merged, or left out altogether (for example, not all described acts or events are necessary for the practice of the algorithms). Moreover, in certain implementations, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

Various illustrative logical blocks, modules, routines, and algorithm steps that may be described in connection with the disclosure herein can be implemented as electronic hardware (e.g., ASICs or FPGA devices), computer software that runs on computer hardware, or combinations of both. Various illustrative components, blocks, and steps may be described herein generally in terms of their functionality. Whether such functionality is implemented as specialized hardware versus software running on general-purpose hardware depends upon the particular application and design constraints imposed on the overall system. The described functionality can be implemented in varying ways for each particular application, but such implementation decisions should not be interpreted as causing a departure from the scope of the disclosure.

Moreover, various illustrative logical blocks and modules that may be described in connection with the implementations disclosed herein can be implemented or performed by a machine, such as a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general purpose processor can be a microprocessor, controller, microcontroller, or state machine, combinations of the same, or the like. A processor can include electrical circuitry configured to process computer-executable instructions. A processor can include an FPGA or other programmable devices that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some, or all, of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of any method, process, routine, or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain features, elements, and/or steps are optional. Thus, such conditional language is not generally intended to imply that features, elements, and/or steps are in any way required or that one or more embodiments necessarily include logic for deciding, with or without other input or prompting, whether these features, elements, and/or steps are included or are to be always performed. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 10 degrees, 5 degrees, 3 degrees, or 1 degree. As another example, in certain embodiments, the terms “generally perpendicular” and “substantially perpendicular” refer to a value, amount, or characteristic that departs from exactly perpendicular by less than or equal to 10 degrees, 5 degrees, 3 degrees, or 1 degree.

As used herein, “real-time” or “substantial real-time” may refer to events (e.g., receiving, processing, transmitting, displaying etc.) that occur at a same time as each other, during a same time as each other, or overlap in time with each other. “Real-time” may refer to events that occur at distinct or non-overlapping times the difference between which is imperceptible and/or inconsequential to humans such as delays arising from electrical conduction or transmission. A human may perceive real-time events as occurring simultaneously, regardless of whether the real-time events occur at an exact same time. As a non-limiting example, “real-time” may refer to events that occur within a time frame of each other that is on the order of milliseconds, seconds, tens of seconds, or minutes. For example, “real-time” may refer to events that occur within a time frame of less than 1 minute, less than 30 seconds, less than 10 seconds, less than 1 second, less than 0.05 seconds, less than 0.01 seconds, less than 0.005 seconds, less than 0.001 seconds, etc.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, “system,” “instrument,” “apparatus,” and “device” generally encompass both the hardware (for example, mechanical and electronic) and, in some implementations, associated software (for example, specialized computer programs for operational control) components.

It should be emphasized that many variations and modifications may be made to the herein-described implementations, the elements of which are to be understood as being among other acceptable examples. All such modifications and variations are intended to be included herein within the scope of this disclosure. Any section headings used herein are merely provided to enhance readability and are not intended to limit the scope of the implementations disclosed in a particular section to the features or elements disclosed in that section. The foregoing description details certain implementations. It will be appreciated, however, that no matter how detailed the foregoing appears in text, the systems and methods can be practiced in many ways. As is also stated herein, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Those of skill in the art would understand that information, messages, and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

While the above detailed description has shown, described, and pointed out novel features, it can be understood that various omissions, substitutions, and changes in the form and details of the devices or algorithms illustrated can be made without departing from the spirit of the disclosure. As can be recognized, certain portions of the description herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A soundbar for monitoring a user's environment with enhanced privacy, comprising:
a speaker configured to emit audio;
a position sensor configured to monitor an environment with microwave radiation and generate position data of the environment responsive to detecting the microwave radiation;
a camera configured to generate image data of an environment, the camera configured to transition between a monitor mode and a standby mode; and
one or more hardware processors configured to:
access position data originating from the position sensor indicating a position of a user within the environment;
in response to determining from the position data that an adverse event has occurred in the environment corresponding to physiological distress of the user, transition the camera from the standby mode to the monitor mode to monitor the environment based on determining that a safety of the user during the adverse event outweighs a privacy of the user;
communicate the image data to a remote computing device; and
generate an audible alert from the speaker.

2. The soundbar of claim 1, wherein the adverse event is a user fall.

3. The soundbar of claim 1, wherein the adverse event is a change in breathing patterns of the user.

4. The soundbar of claim 1, wherein the one or more hardware processors are configured to generate a notification that additional monitoring will commence in response to determining from the position data that the adverse event has occurred.

5. The soundbar of claim 1, wherein the one or more hardware processors are configured to transition the camera to the monitor mode by at least powering on the camera.

6. The soundbar of claim 1, further comprising a buffer configured to store image data from the camera as non-persistent data, wherein the one or more hardware processors are configured to transition the camera to the monitor mode by at least changing a length of time the image data persists in the buffer before being deleted.

7. The soundbar of claim 1, further comprising a buffer configured to store image data from the camera as non-persistent data, wherein the one or more hardware processors are configured to transition the camera to the monitor mode by at least storing the image data from the buffer in long term memory as persistent data.

8. The soundbar of claim 1, wherein the image data includes data generated by the camera before and/or during the adverse event when the camera is in the standby mode, wherein the image data is stored in a buffer as non-persistent data during the standby mode.

9. The soundbar of claim 1, wherein the one or more hardware processors are configured to verify that the adverse event has occurred from the image data generated by the camera.

10. The soundbar of claim 1, wherein the one or more hardware processors are configured to determine the adverse event has occurred if a condition in the position data persists for longer than a threshold time.

11. The soundbar of claim 1, further comprising an environment sensor, wherein the one or more hardware processors are configured to:
access user agnostic data originating from the environment sensor, said user agnostic data including one or more of environment temperature data, ambient light data, or air quality data; and
determine that the adverse event has occurred from the user agnostic data in combination with the position data.

12. The soundbar of claim 1, further comprising a microphone, wherein the one or more hardware processors are configured to:
access audio data originating from the microphone; and
determine that the adverse event has occurred from the audio data in combination with the position data.

13. The soundbar of claim 1, wherein the one or more hardware processors are configured to:
access physiological data originating from a user device connected to the user; and
determine that the adverse event has occurred from the physiological data in combination with the position data.

14. A method of monitoring an environment with an audio device, comprising:
accessing position data originating from a position sensor responsive to detecting microwave radiation within the environment, said position data indicating a position of a user within the environment;
in response to determining from the position data that an event has occurred in the environment, transitioning a camera from a standby mode to a monitor mode to monitor the environment within images collected by the camera;
communicating the images to a remote computing device; and
generating an audible alert from a speaker of the audio device relating to the event.

15. The method of claim 14, further comprising generating a notification that additional monitoring will commence in response to determining from the position data that the event has occurred.

16. The method of claim 14, further comprising storing the images from the camera in a buffer as non-persistent data, wherein transitioning the camera to the monitor mode includes at least changing a length of time the images persist in the buffer before being deleted.

17. The method of claim 14, further comprising:
accessing user agnostic data originating from an environment sensor, said user agnostic data including one or more of environment temperature data, ambient light data, or air quality data; and
determining that the event has occurred from the user agnostic data in combination with the position data.

18. Non-transitory computer-readable media including computer-executable instructions that, when executed by a computing system, cause the computing system to perform operations comprising:
accessing position data originating from a position sensor responsive to detecting microwave radiation within an environment, said position data indicating a position of a user within the environment;
in response to determining from the position data that an event has occurred in the environment, transitioning a camera from a standby mode to a monitor mode to monitor the environment within images collected by the camera;
communicating the images to a remote computing device; and
generating an audible alert from a speaker of an audio device relating to the event.

19. The non-transitory computer-readable media of claim 18, wherein the computer-executable instructions, when executed by the computing system, cause the computing system to perform operations comprising generating a notification that additional monitoring will commence in response to determining from the position data that the event has occurred.

20. The non-transitory computer-readable media of claim 18, wherein the computer-executable instructions, when executed by the computing system, cause the computing system to perform operations comprising storing the images from the camera in a buffer as non-persistent data, wherein transitioning the camera to the monitor mode includes at least changing a length of time the images persist in the buffer before being deleted.
